(19) United States
(12) Patent Application Publication
(10) Pub. No.: US 2025/0160262 A1
(43) Pub. Date: May 22, 2025

(54) Magnetic Device and Method for Growing Plants

(71) Applicant: Welivitigoda Rajitha Danesha WIMALADHARMA, Colombo (LK)

(72) Inventor: Welivitigoda Rajitha Danesha WIMALADHARMA, Colombo (LK)

(21) Appl. No.: 18/841,434

(22) PCT Filed: Feb. 21, 2023
(86) PCT No.: PCT/SG2023/050101

§ 371 Date: Aug. 26, 2024

Related U.S. Application Data
(63) Continuation of application No. 17/679,711, filed on Feb. 24, 2022, now Pat. No. 11,612,109.

(51) Int. Cl. A01G 7/04

(52) U.S. Cl. CPC A01G 7/04

(57) ABSTRACT

The present disclosure generally relates to a magnetic device and method for growing plants. Plants can be grown axially out of a space in the magnetic device and the base of the plants are surrounded by magnetic elements that generate a magnetic field. The magnetic elements are rotated around the space such that the base of the plants is surrounded by the magnetic elements and exposed to the rotating magnetic field, which thereby enhances growth of the plants.

### CROSS REFERENCE TO RELATED APPLICATION(S)

The present disclosure claims the benefit of U.S. patent application Ser. No. 17/679,711 filed on 24 Feb. 2022, which is incorporated in its entirety by reference herein.

### TECHNICAL FIELD

The present disclosure generally relates to a magnetic device and a method for growing plants.

### BACKGROUND

The world's human population is projected to grow by at least 20% by the year 2050 but some studies have shown that food demand needs to increase by some 70% to feed the world's population in the year 2050. Various agricultural technologies and ⁱinnovations have been developed to increase crop production and improve crop quality. Some studies have shown that magnetic fields have positive effects on crop or plant growth. For example, WO 2021030161 describes electromagnetic treatment of plants to improve plant growth and reduce plant pests. Given the increasing food demand in the future, there is a need to provide an improved device and method for growing plants.

### SUMMARY

According to a first aspect of the present disclosure, there is a magnetic device for growing plants. The magnetic device comprises: a body comprising a space for enclosing a base of the plants and growing the plants axially out of the space along a vertical axis; a set of magnetic elements coupled to the body and surrounding the space about the vertical axis, the magnetic elements configured for generating a magnetic field in the space; and an actuation mechanism coupled to the body and configured for rotating the magnetic elements around the space and about the vertical axis, thereby rotating the magnetic field around the space and about the vertical axis, wherein in use, the base of the plants is surrounded by the magnetic elements and exposed to the rotating magnetic field to thereby enhance growth of the plants.

According to a second aspect of the present disclosure, there is a method for growing plants. The method comprises: enclosing a base of the plants within a space of a device body; growing the plants axially out of the space along a vertical axis; generating a magnetic field in the space by a set of magnetic elements coupled to the device body, the magnetic elements surrounding the space about the vertical axis and surrounding the base of the plants; rotating the magnetic elements around the space and about the vertical axis by an actuation mechanism coupled to the device body to thereby rotate the magnetic field around the space and about the vertical axis; and exposing the base of the plants to the rotating magnetic field to thereby enhance growth of the plants.

A magnetic device and method for growing plants according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIGS. 1A to 1D are illustrations of a magnetic device for growing plants, in accordance with embodiments of the present disclosure.

FIGS. 2A to 2C are illustrations of magnetic elements of the magnetic device.

FIG. 3 is a flowchart illustration of a method for growing plants using the magnetic device.

FIGS. 4A to 4G are illustrations of an experiment on growing tobacco plants using the magnetic device.

FIGS. 5A to 5J are illustrations of an experiment on growing spinach plants using the magnetic device.

FIGS. 6A to 6Q are illustrations of an experiment on growing tomato plants using the magnetic device.

FIGS. 7A to 7P are illustrations of an experiment on growing basil plants using the magnetic device.

### DETAILED DESCRIPTION

For purposes of brevity and clarity, descriptions of embodiments of the present disclosure are directed to a magnetic device and method for growing plants, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

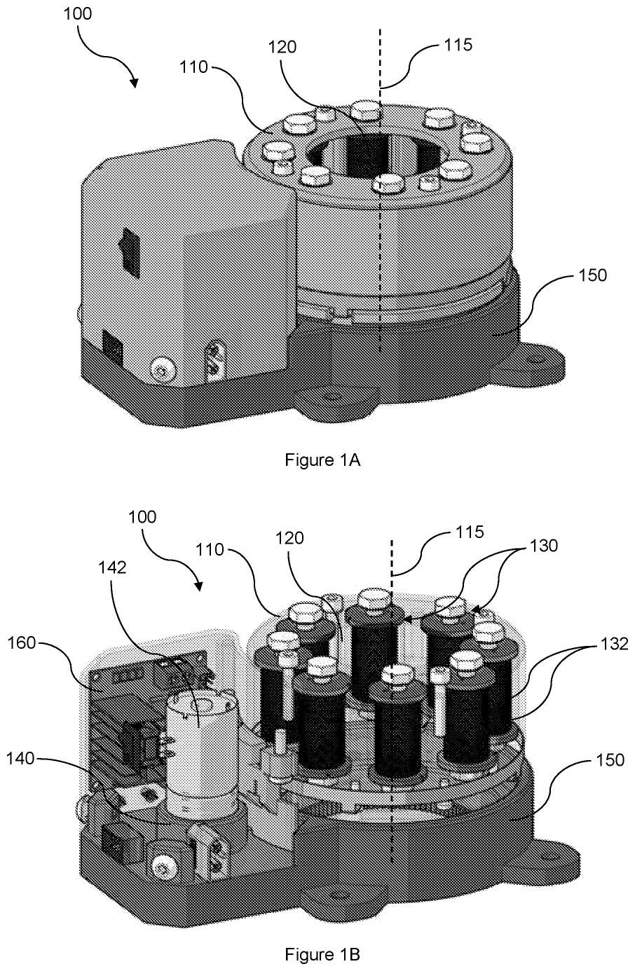

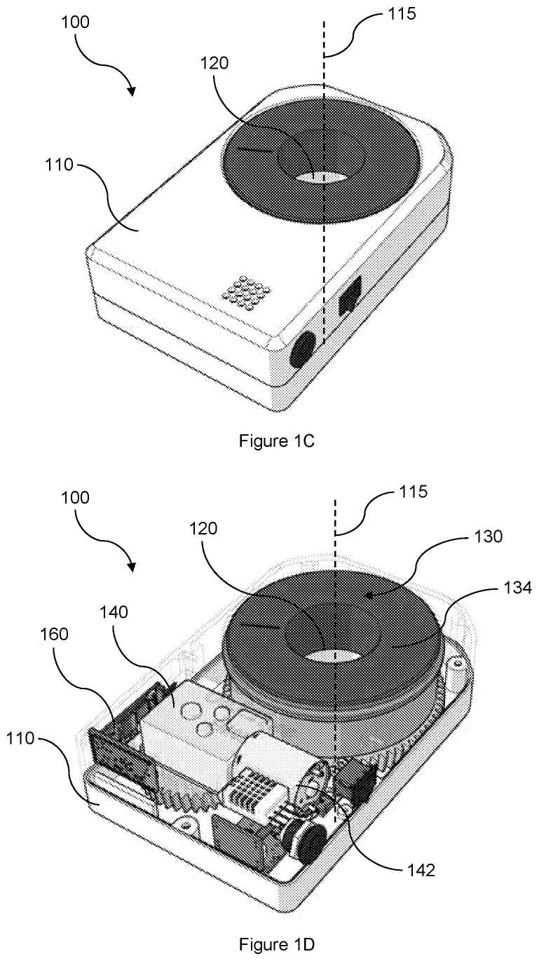

In representative or exemplary embodiments of the present disclosure, as shown in FIGS. 1A to 1D, there is a magnetic device 100 for growing plants. The magnetic device 100 includes a body 110 having a space 120 for enclosing a base of the plants and growing the plants axially out of the space 120. More specifically, the plants are grown axially out of the space 120 generally along the vertical axis 115. For example, the body 110 has an annular structure with a central hole as the space 120 for enclosing the base of the plants. The base of the plants can include the roots and part of the plant stem or tree trunk. The plants are vascular plants of any size, including small plants like ferns and large plants like trees.

The magnetic device 100 further includes a set of magnetic elements 130, such as permanent magnets and/or electromagnets, coupled to the body 110 and surrounding the space 120. The magnetic elements 130 are configured for generating a magnetic field in the space 120. The magnetic field may include an axial magnetic field axially through the space 120 and along the vertical axis 115. The magnetic field may include a diametrical magnetic field diametrically across the space 120 and perpendicular to the vertical axis 115. The magnetic field may include both the axial magnetic field and the diametrical magnetic field.

In some embodiments as shown in FIGS. 1A and 1B, the magnetic elements 130 may include a set of electromagnets. For example, the set of electromagnets includes a single electromagnet. Alternatively, a plurality of electromagnets, such as semi-circular ones, may collectively form the magnetic elements 130 surrounding the space 120. For example, one semi-circular electromagnet may be the North pole and another semi-circular electromagnetic may be the South pole, thus generating the diametrical magnetic field. Each electromagnet may include an electric wire 132 wound around a magnetic core made from a ferromagnetic material such as iron. Electric current flow to the electric wires 132 may be controlled to vary the magnetic strength of the axial magnetic field. Notably, the polarities of the magnetic elements 130 can be reversed if the electric current flow changes direction.

In some embodiments as shown in FIGS. 1C and 1D, the magnetic elements 130 may include a set of permanent magnets, such as neodymium magnets or samarium cobalt magnets. For example, the permanent magnets may include or form a ring magnet 134. For example, the set of permanent magnets includes a single ring magnet 134. Alternatively, a plurality of permanent magnets collectively form the ring magnet 134, such as a pair of semi-circular magnets. For example, the ring magnet 134 may have the North and South poles along the vertical axis 115 to generate the axial magnetic field. The South pole may face upwards and the North pole may face downwards.

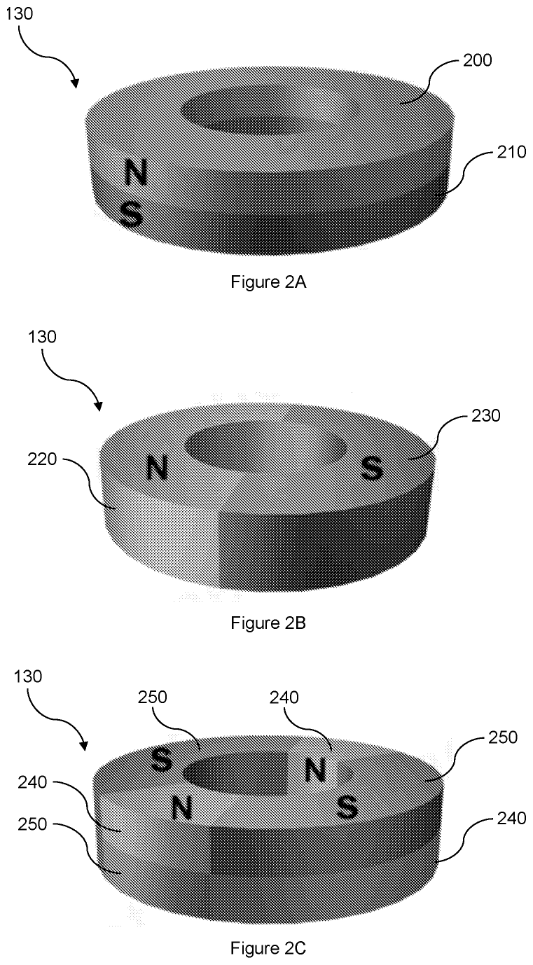

In some embodiments as shown in FIG. 2A, the magnetic field includes the axial magnetic field that is directed axially through the space 120 and along the vertical axis 115. For example, the magnetic elements 130 include an upper ring magnet 200 being the North pole and a lower ring magnet 210 being the South pole. The magnetic elements 130 are axially magnetized such that the North-South axis of the magnetic elements 130 is generally parallel to the vertical axis 115.

In some embodiments as shown in FIG. 2B, the magnetic field includes the diametrical magnetic field that is directed diametrically across the space 120 and perpendicular to the vertical axis 115. For example, the magnetic elements 130 include a first semi-circular magnet 220 being the North pole and a second semi-circular magnet 230 being the South pole. The magnetic elements 130 are diametrically magnetized such that the North-South axis of the magnetic elements 130 is generally perpendicular to the vertical axis 115.

In some embodiments as shown in FIG. 2C, the magnetic field includes the both the axial magnetic field and the diametrical magnetic field. For example, the magnetic elements 130 include a plurality of first magnets 240 being the North poles and a plurality of second magnets 250 being the South poles. The first magnets 240 and second magnets 250 are arranged such that some of the magnetic elements 130 are axially magnetized and some of the magnetic elements 130 are diametrically magnetized. The magnetic field may further include a magnetic field that is directed diagonally across the space 120 and oblique to the vertical axis 115.

The magnetic device 100 further includes an actuation mechanism 140, such as an electric motor and/or a mechanically-activated mechanism, coupled to the body 110. The actuation mechanism 140 is configured for rotating the magnetic elements around the space 120, thereby rotating the magnetic field around the space 120. For example as shown in FIGS. 1B and 1D, the actuation mechanism 140 may include an electric motor 142, such as a DC gear motor, configured for automatically and continuously rotating the magnetic elements 130. For example, the rotational speed of the magnetic elements 130 may be one revolution every three minutes. The electric motor 142 may be controlled to vary the rotational speed of the magnetic elements 130, such as depending on the stage of plant growth. Additionally or alternatively, the actuation mechanism 140 may include a mechanically-activated mechanism for manual rotation of the magnetic elements 130, such as in absence of power or if the electric motor 142 malfunctions. For example, such mechanism can be manually activated by a biasing element (e.g. a spring) or by some form of kinetic motion.

In some embodiments such as shown in FIG. 1C, the body 110 and actuation mechanism 140 are directly coupled together or integrally formed with each other. In some embodiments such as shown in FIG. 1A, the magnetic device 100 includes a device base 150 for supporting the body 110 and actuation mechanism 140 and coupling them together. Various parts of the magnetic device 100 is preferably made of a waterproof material to shield the electronic components as the magnetic device 100 is designed to be used for plant growth wherein water irrigation is essential.

In some embodiments, the magnetic device 100 includes a control unit 160 for controlling the magnetic elements 130 and/or actuation mechanism 140. For example, the magnetic elements 130 include electromagnets and the control unit 160 can control the electric current flow to the electric wires 132 and thereby vary the magnetic strength of the magnetic field generated by the electromagnets. The control unit 160 can control the actuation mechanism 140, such as the electric motor 142, to vary the rotational speed of the magnetic elements 130. The control unit 160 may control the actuation mechanism 140 to rotate the magnetic elements 130 in predefined patterns, such as at a first rotational speed for a first duration and then a second rotational speed for a second duration. The magnetic strength and rotational speed can vary depending on factors such as the plant species, stage of plant growth, and ambient conditions. The ambient conditions can include one or more of temperature, humidity, and soil moisture. For example, the rotational speed may be reduced when the plants grow to the flowering stage, so as to reduce magnetic stresses experienced by the plants during the flowering stage and thereby optimize plant growth.

In some embodiments, the magnetic device 100 includes a set of sensors for measuring the ambient conditions of the environment in which the plants are grown. For example, the ambient conditions may include temperature and/or humidity of the environment, as well as moisture in the soil where the plants are grown. The sensors may be communicative with the control unit 160 to facilitate decision control of the rotation of the magnetic elements 130 based on the ambient conditions. The control unit 160 may be communicative with a remote electronic device, such as a mobile phone or computer system, for remote control of the magnetic device 100.

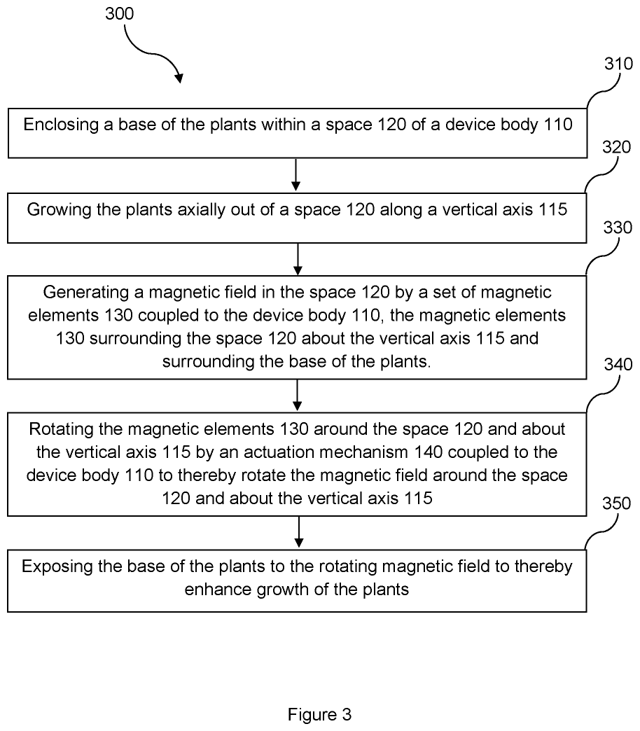

In various embodiments of the present disclosure, with reference to FIG. 3, there is a method 300 for growing plants. The method 300 may be performed using various devices, such as the magnetic device 100 as described herein.

The method 300 includes a step 310 of enclosing a base of the plants within a space 120 of a device body 110. The method 300 includes a step 320 of growing the plants axially out of a space 120 along a vertical axis 115. The method 300 includes a step 330 of generating a magnetic field in the space 120 by a set of magnetic elements 130 coupled to the device body 110, the magnetic elements 130 surrounding the space 120 about the vertical axis 115 and surrounding the base of the plants. The method 300 includes a step 340 of rotating the magnetic elements 130 around the space 120 and about the vertical axis 115 by an actuation mechanism 140 coupled to the device body 110 to thereby rotate the magnetic field around the space 120 and about the vertical axis 115. The method 300 includes a step 350 of exposing the base of the plants to the rotating magnetic field to thereby enhance growth of the plants.

When the magnetic device 100 is in use for growing plants, the base of the plants is exposed to the rotating magnetic field, which can include the axial magnetic field and/or diametrical magnetic field, to thereby enhance growth of the plants. As described further below, various experiments were performed on various species of plants, such as tobacco, spinach, tomato, and basil, to show the effectiveness of the rotating magnetic field in enhancing plant growth.

Various experiments were performed to investigate the effectiveness of the magnetic device 100, particularly the rotating magnetic field comprising an axial magnetic field, in enhancing plant growth. More specifically, two magnetic devices 100 were used in these experiments—an axial magnetic device 100A that generates the rotating magnetic field which includes only the axial magnetic field, and a control magnetic device 100B that generates a static axial magnetic field such as by using a fixed ring magnet. These experiments were performed on tobacco plants 400, spinach plants 500, and tomato plants 600.

In the experiment on tobacco plants 400, two samples of tobacco plants 400 of similar size were selected from the same batch. The first sample 400A was grown using the axial magnetic device 100A and the second sample 400B was grown using the control magnetic device 100B. The axial magnetic fields are such that the North pole is facing upwards and the South pole is facing downwards, such as the arrangement shown in FIG. 2A. The magnetic strength of the axial magnetic device 100A and control magnetic device 100B are approximately equal and ranges from 6,000 to 12,000 Gauss.

Both samples of tobacco plants 400A,400B were grown using hydroponics for better accuracy in delivering the same amount of nutrients, thereby ensuring that the plant growth conditions are identical except for the static and rotating axial magnetic fields. The tobacco plants 400A,400B were exposed to 24 hours of continuous LED lighting per day.

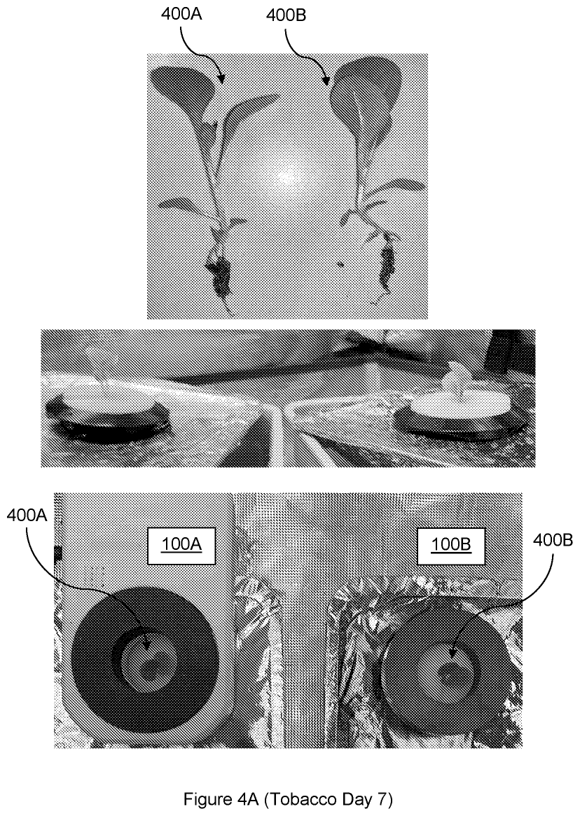

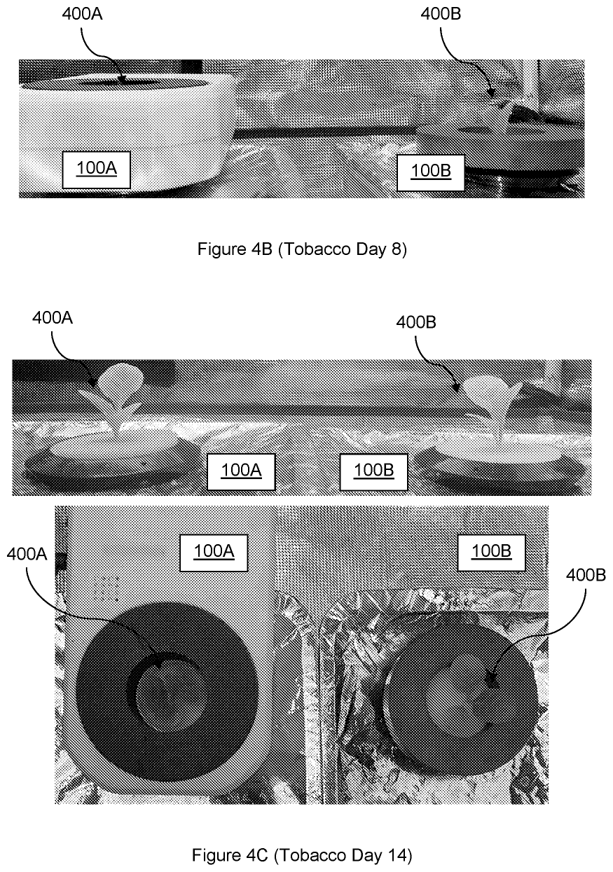

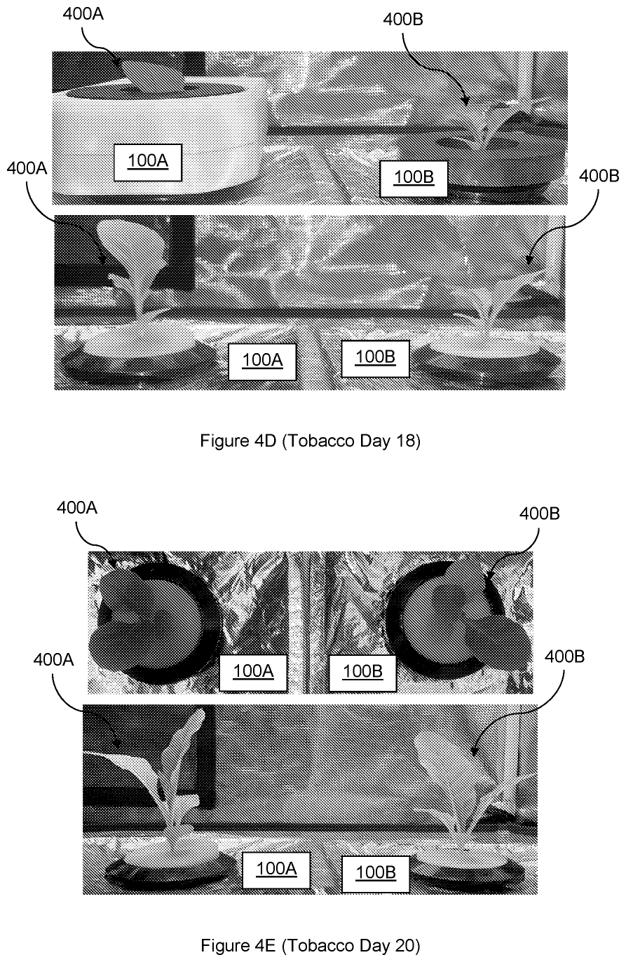

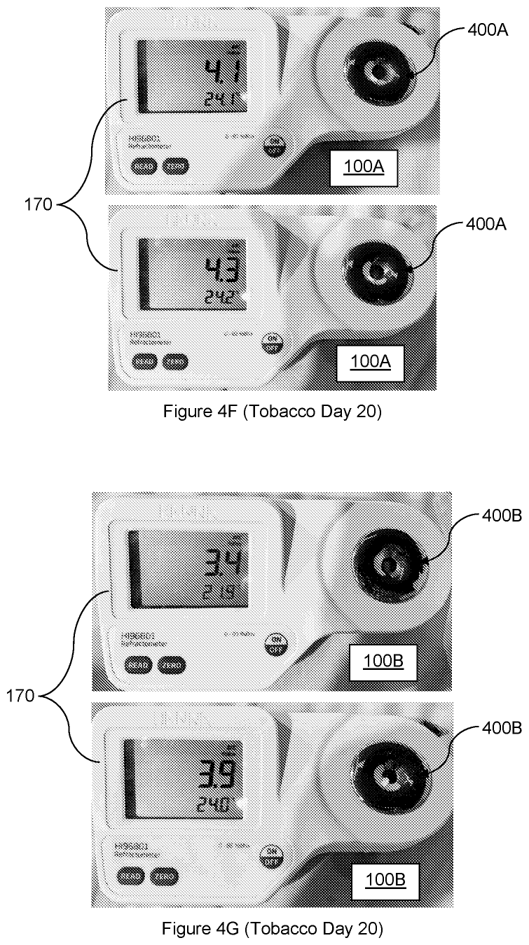

Photos of the growth of the tobacco plants 400A,400B over 20 days are shown in FIGS. 4A to 4G. Additionally, sugar levels of both tobacco plants 400A,400B were measured using a brix refractometer 170 on Day 20. As shown in FIG. 4F, the tobacco plant 400A grown using the axial magnetic device 100A had sugar levels of 4.1% and 4.3% from two separate measurements. As shown in FIG. 4G, the tobacco plant 400B grown using the control magnetic device 100B had sugar levels of 3.4% and 3.9% from two separate measurements. The tobacco plant 400A had an average of 15% increase in sugar quantity compared to the tobacco plant 400B. These results indicate that the rotating axial magnetic field from the axial magnetic device 100A has positive effects on sucrose production in tobacco plants 400.

An experiment similar to that for the tobacco plants 400 was performed for the spinach plants 500 using two samples thereof 500A,500B and also with hydroponics. The smaller-sized first sample 500A was grown using the axial magnetic device 100A and the larger-sized second sample 500B was grown using the control magnetic device 100B.

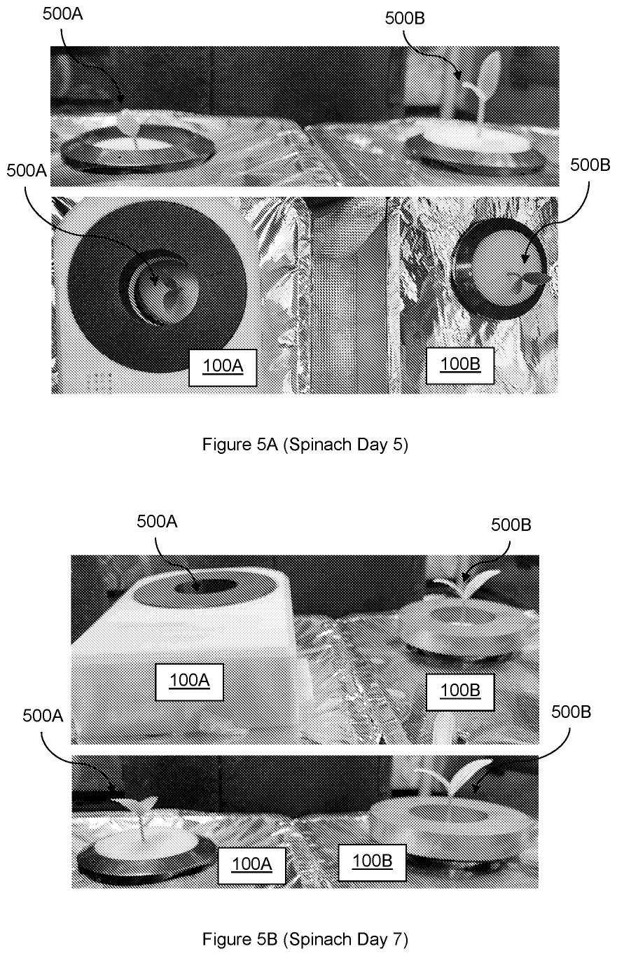

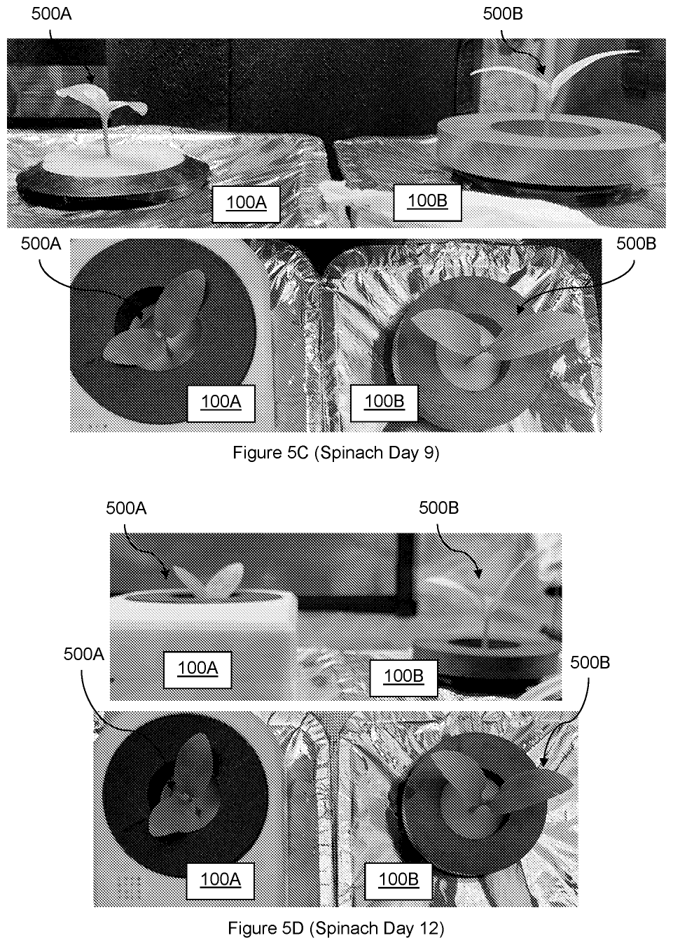

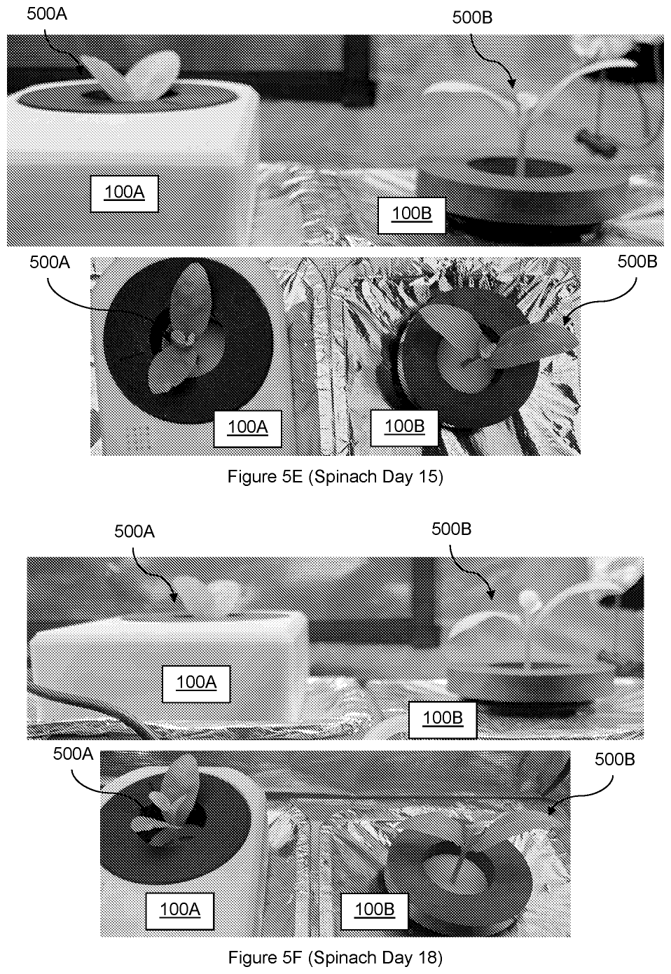

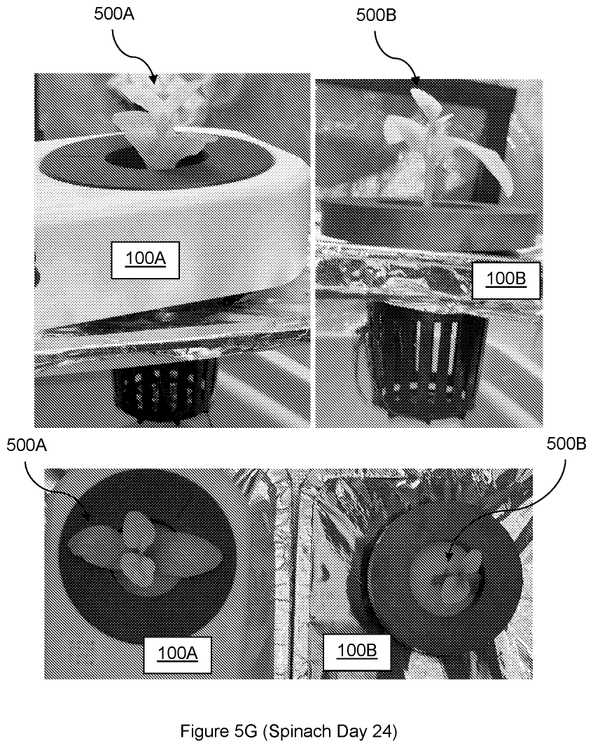

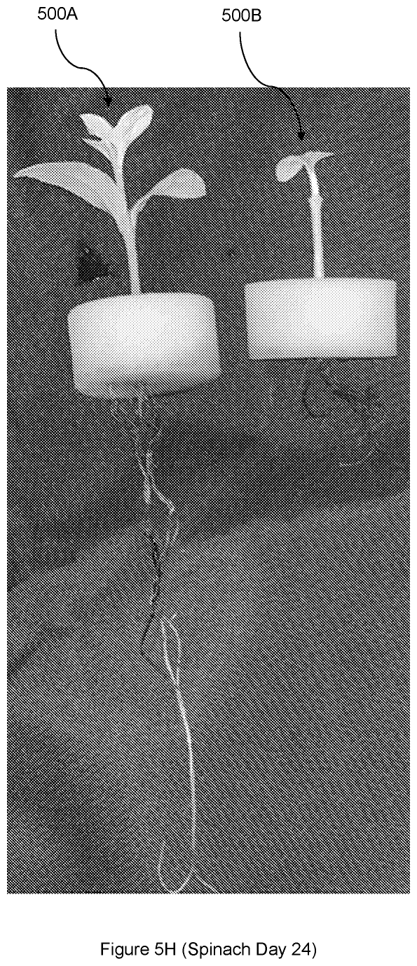

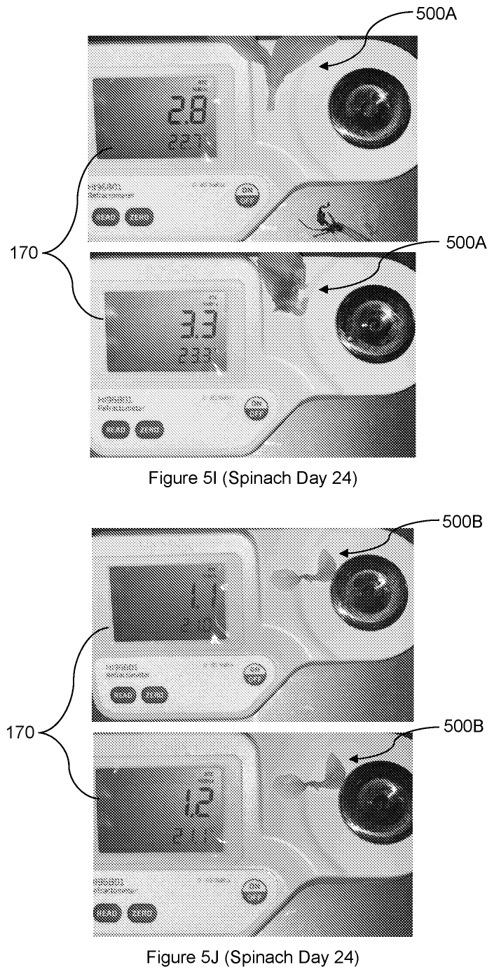

Photos of the growth of the spinach plants 500A,500B over 24 days are shown in FIGS. 5A to 5J. Additionally, sugar levels of both spinach plants 500A,500B were measured using the brix refractometer 170 on Day 24. As shown in FIG. 5I, the spinach plant 500A grown using the axial magnetic device 100A had sugar levels of 2.8% and 3.3% from two separate measurements. As shown in FIG. 5J, the spinach plant 500B grown using the control magnetic device 100B had sugar levels of 1.1% and 1.2% from two separate measurements. The spinach plant 500A had an average of 65% increase in sugar quantity compared to the spinach plant 500B. Moreover, as shown in FIG. 5H, the spinach plant 500A had significantly more root mass than the spinach plant 500B, despite the spinach plant 500A being originally smaller than the spinach plant 500B. These results indicate that the rotating axial magnetic field from the axial magnetic device 100A has positive effects on sucrose production and root mass growth in spinach plants 500.

A different experiment was performed for the tomato plants 600. Two samples of tomato plants 600 of similar size were selected from the same batch. Each sample 600A,600C contains three separate tomato plants 600. The first sample 600A was grown using the axial magnetic device 100A and the second sample 600C was grown normally in a control setup 100C that is without any magnetic device, i.e. without any artificially generated magnetic field. For the first sample 600A, the axial magnetic device 100A is arranged such that the South pole is facing upwards and the North pole is facing downwards, and the magnetic strength is about 6,000 to 12,000 Gauss.

Both samples of tomato plants 600A,600C were grown using a soil-based system instead of hydroponics. All other conditions such as temperature and lighting are identical for both tomato plants 600A,600C. For the first 60 days, the tomato plants 600A,600C were exposed to 24 hours of continuous LED lighting per day. After day 60 which is during the fruiting stage, the tomato plants 600A,600C were exposed to 12 hours of LED lighting and 12 hours of darkness per day.

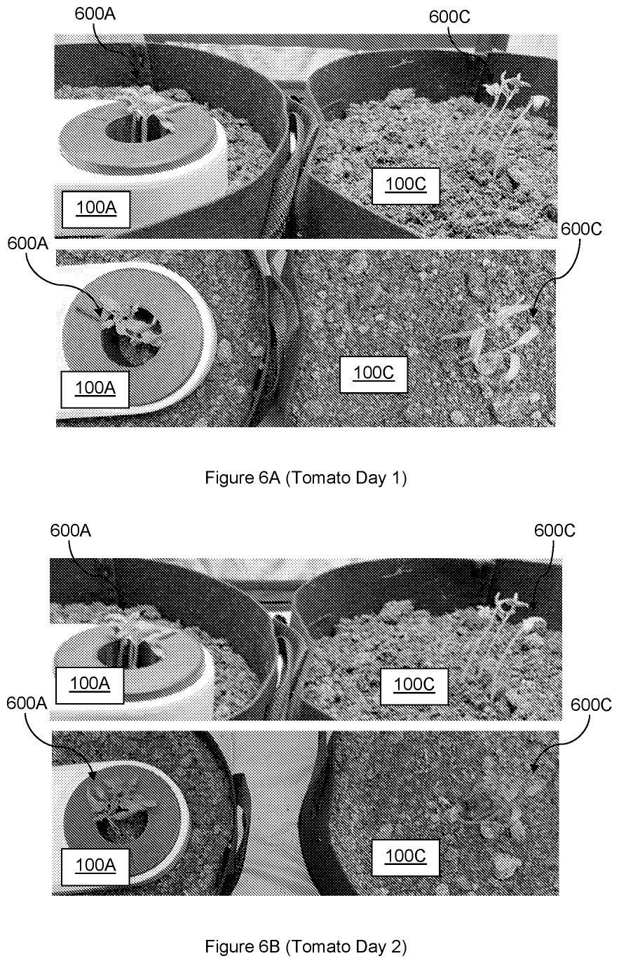

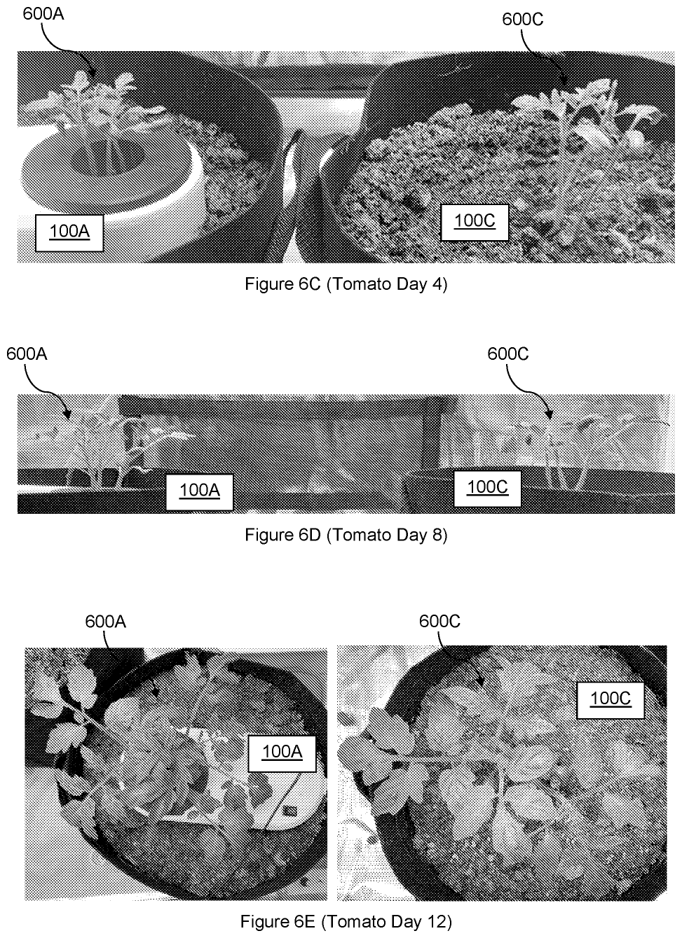

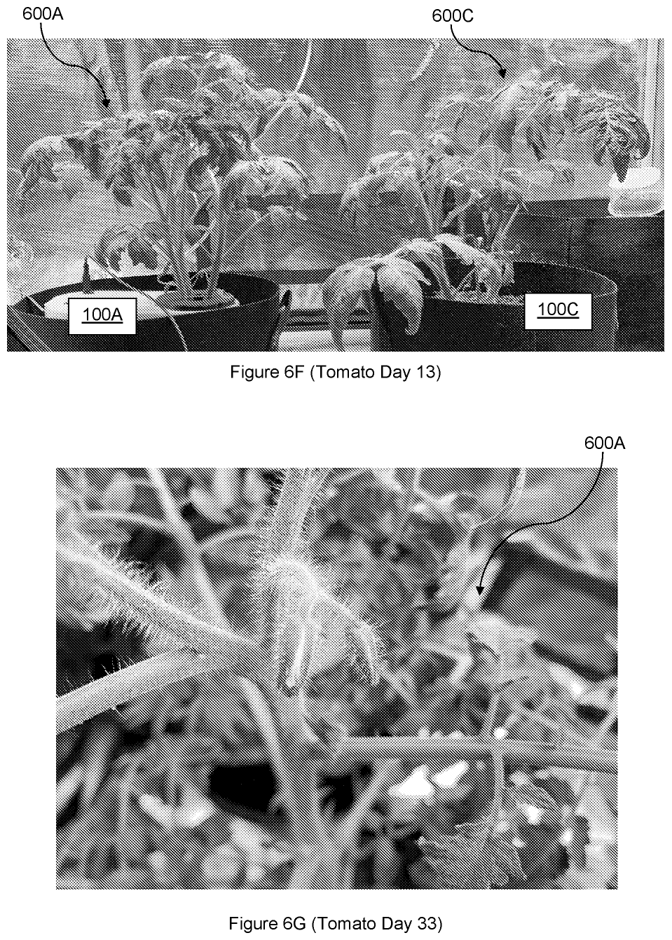

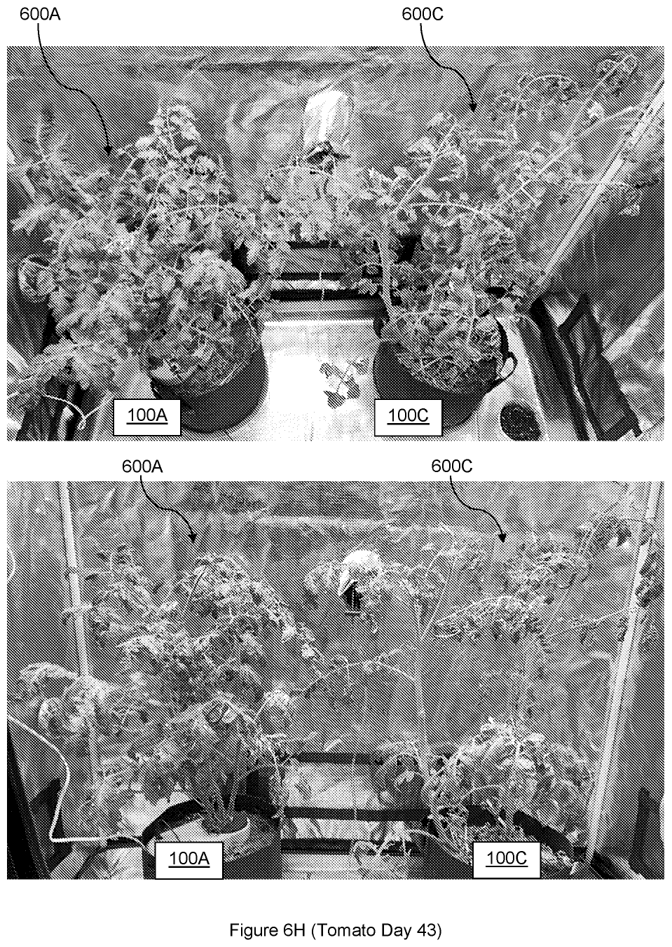

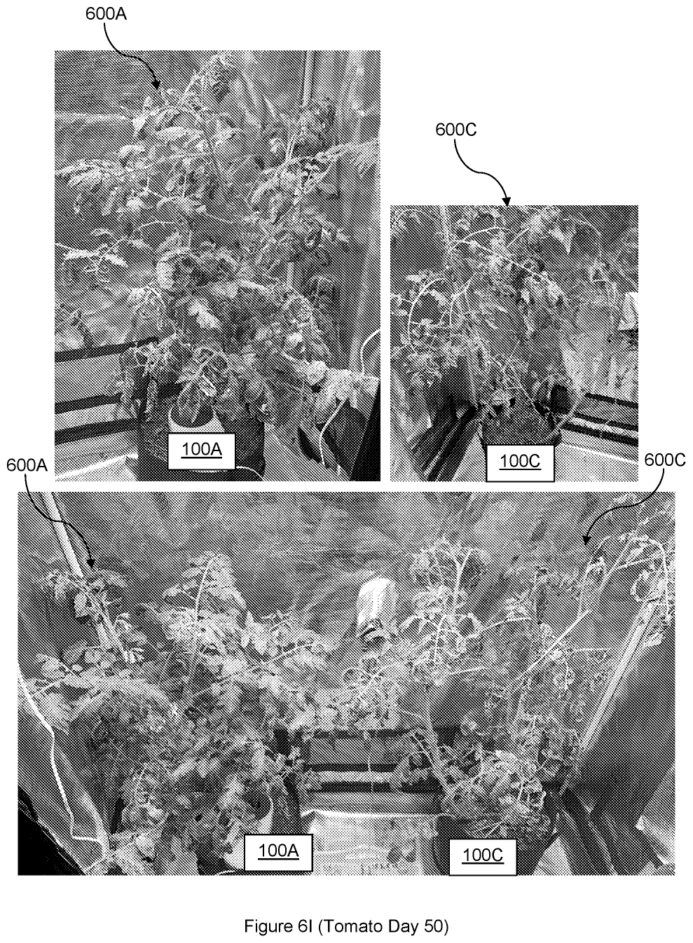

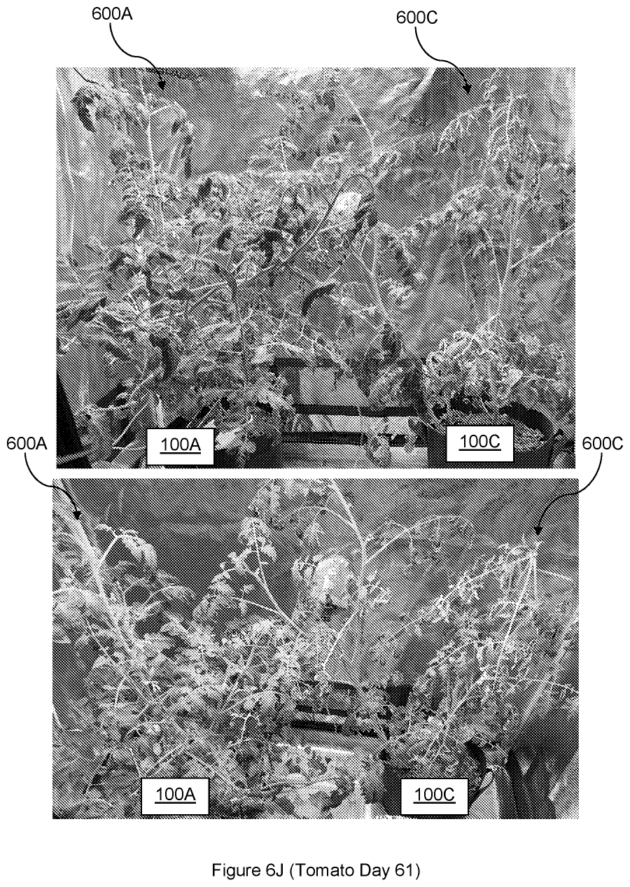

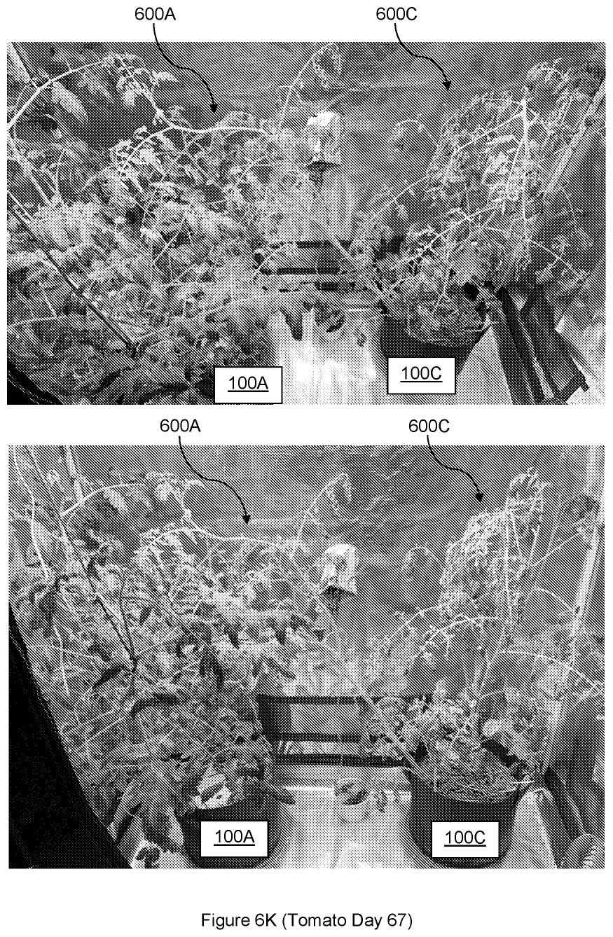

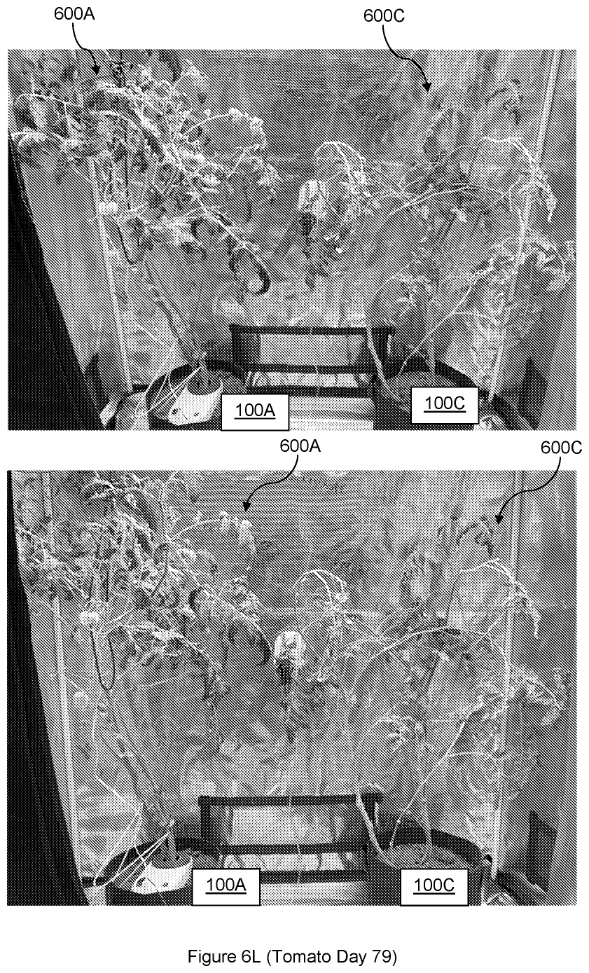

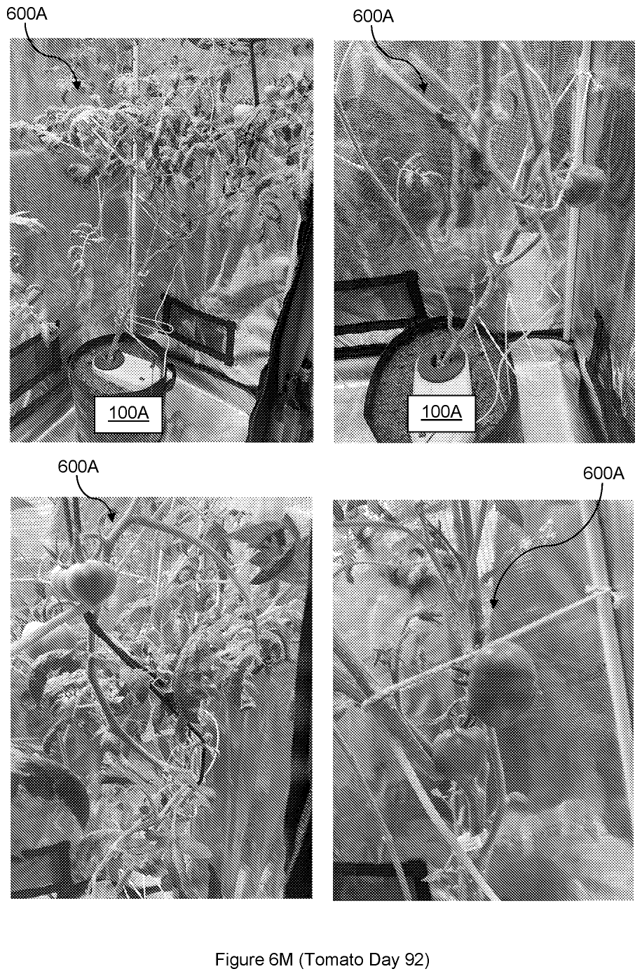

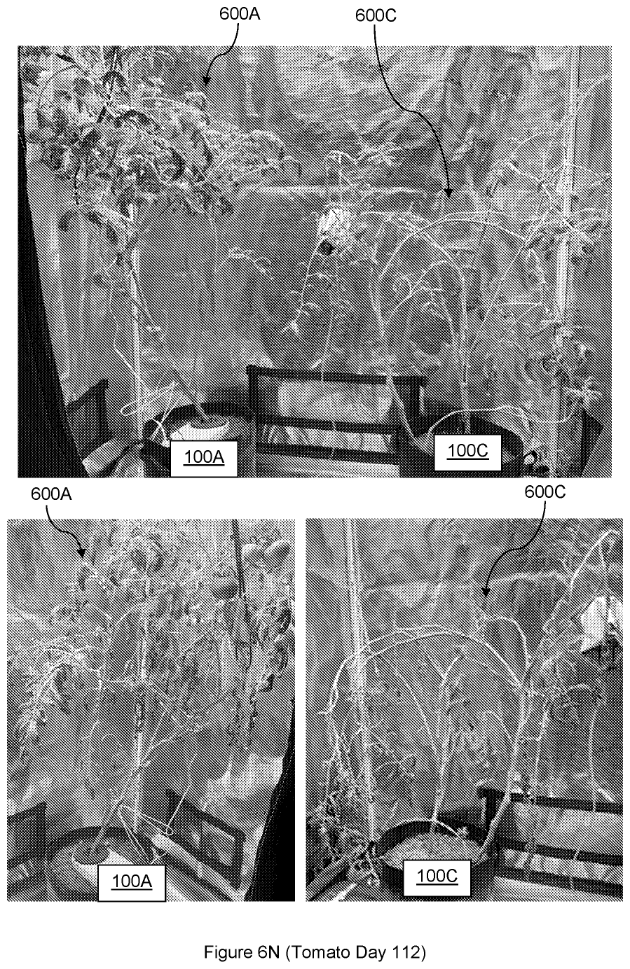

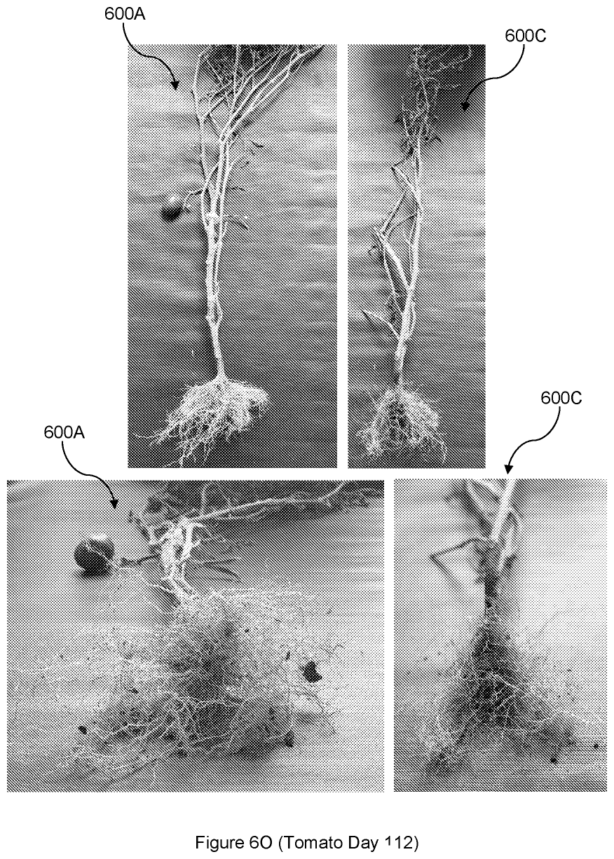

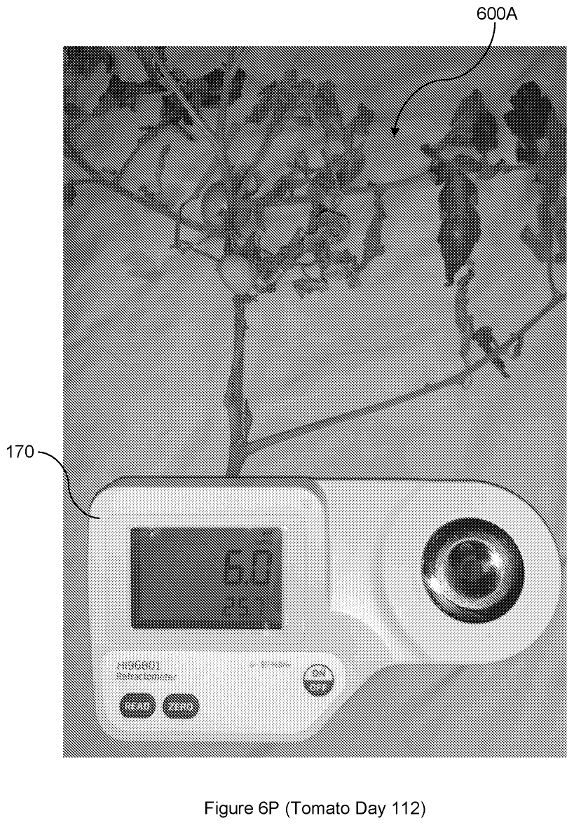

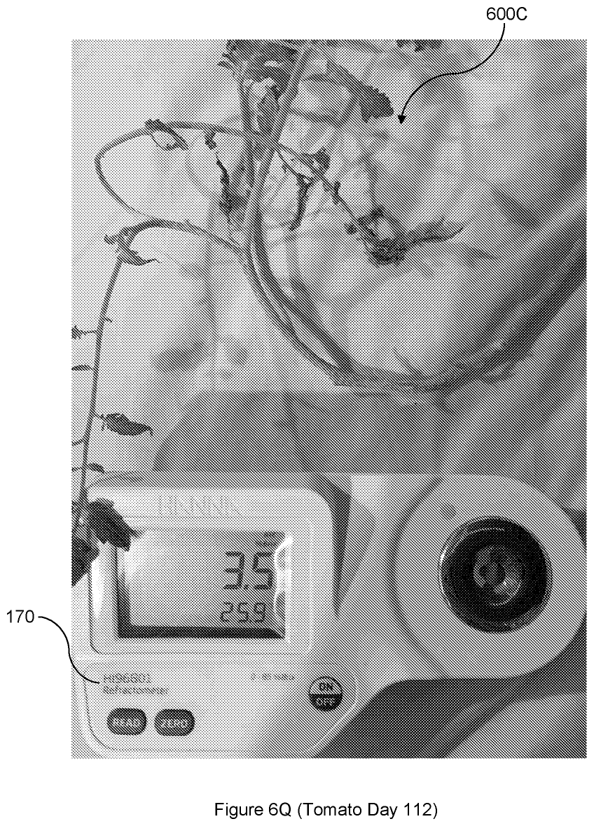

Photos of the growth of the tomato plants 600A,600C over 112 days are shown in FIGS. 6A to 6Q. Both tomato plants 600A, 600C were growing healthily after 1 month. On Day 33, flowers can be seen on the tomato plant 600A but not yet for the tomato plant 600C until around two weeks later. On Day 60, the tomato plant 600A is healthy and strong and had started fruiting. Comparatively, on Day 60, the tomato plant 600C had flowered but had not started fruiting yet. The tomato plant 600C is also weaker and its growth had stunted, possibly because it is less resistant to temperature variations as the tomato plants 600A,600C were grown in temperatures colder than what the tomato species tends to thrive in. On Day 60, fungi also started attacking the tomato plants 600A,600C and by Day 70, mould was found to be growing on both tomato plants 600A,600C due to high humidity in the environment. However, the tomato plant 600A showed greater resistance to the fungi attack than the tomato plant 600C. The tomato plant 600A had also fruited but the tomato plant 600C had not fruited yet. On Day 92, the tomato plant 600A had around 10-15 tomato fruits that were ripe and red. About one-third had ripened and were ready for consumption. The tomato plant 600C had not flowered or fruited and it had lost about 60% of its mass. On Day 112 which is the last day of the experiment, the tomato plant 600C still had not fruited yet.

Additionally, sugar levels of both tomato plants 600A, 600C were measured using the brix refractometer 170 on Day 112. As shown in FIG. 6P, the tomato plant 600A grown using the axial magnetic device 100A had a sugar level of 6.0%. As shown in FIG. 6Q, the tomato plant 600C grown normally in the control setup 100C without any magnetic device had a sugar level of 3.5%. The tomato plant 600A had about 70% increase in sugar quantity compared to the tomato plant 600C. Moreover, as shown in FIG. 6O, the roots of the tomato plant 600A were healthier looking and had more root mass than the roots of the tomato plant 600C. These results indicate that the rotating axial magnetic field from the axial magnetic device 100A has positive effects on sucrose production and root mass growth in tomato plants 600.

The results from these experiments showed that when the plants are grown within the space 120 of the axial magnetic device 100A and the base of the plants is exposed to the rotating axial magnetic field, the plant growth is enhanced and the rotating axial magnetic field achieves superior results on the plant growth, particularly increased sucrose production and larger root mass. There is also improved weather resistance, such as to temperature variations, and greater resistance to attacks by fungi.

The axial magnetic field enables both the plants and the soil under the plants to be magnetized, which in turn stimulates root growth. The arrangement of the magnetic poles may depend on the species of plants grown using the axial magnetic device 100A. For example for aboveground plants or crops, the South pole faces upwards to magnetize the crops and the North pole faces downwards to magnetize the soil. For underground plants or crops, the polarity arrangement may reverse. The axial magnetic device 100A is thus able to enhance plant growth by using the axial magnetic field that is generally parallel to the stem axis of the plants. The base of the plants is exposed to the axial magnetic field that is continuously rotating to evenly distribute the axial magnetic field around the plants.

Another experiment was performed to investigate the effectiveness of the magnetic device 100, particularly the differences between a rotating axial magnetic field and a rotating diametrical magnetic field, in enhancing plant growth. More specifically, three setups were used in this experiment—an axial magnetic device 100A that generates the rotating magnetic field which includes only the axial magnetic field, and a diametrical magnetic device 100D that generates the rotating magnetic field which includes only the diametrical magnetic field, and a control setup 100C that is without any magnetic device, i.e. without any artificially generated magnetic field. This experiment was similar to that for the tobacco plants 400 and spinach plants 600, but was performed for basil plants 700 instead.

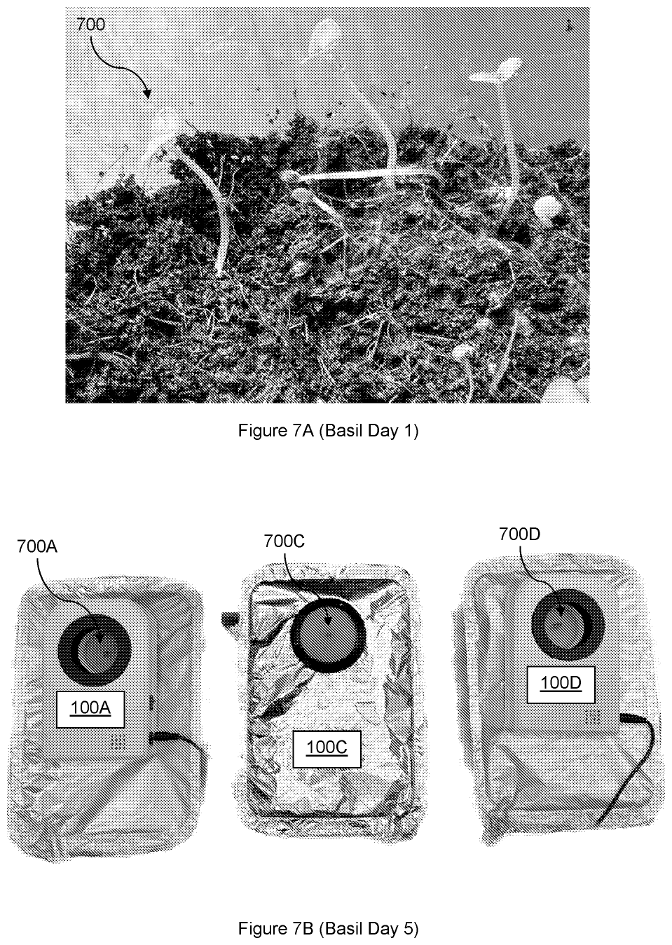

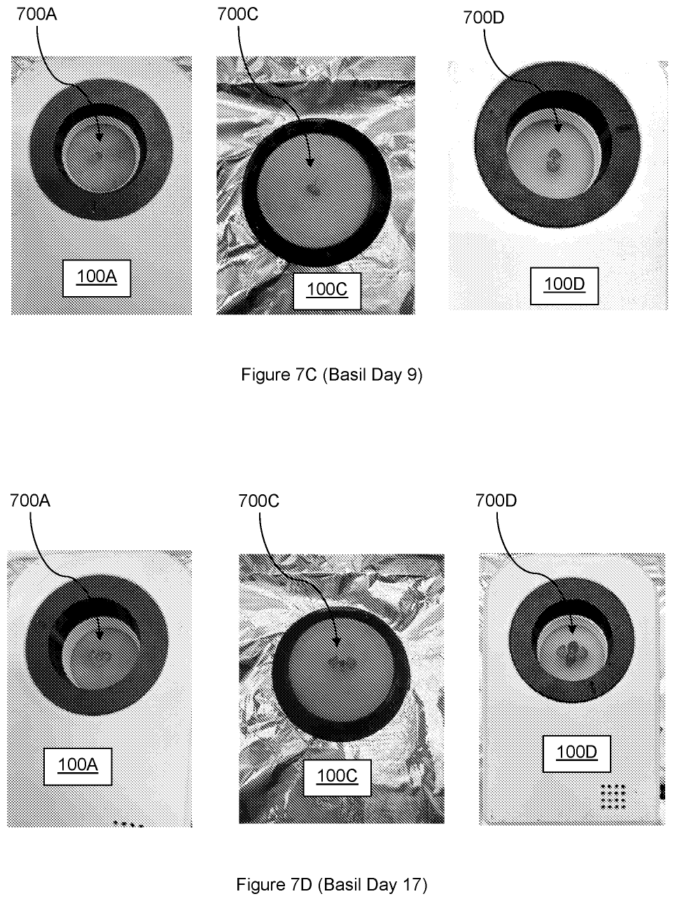

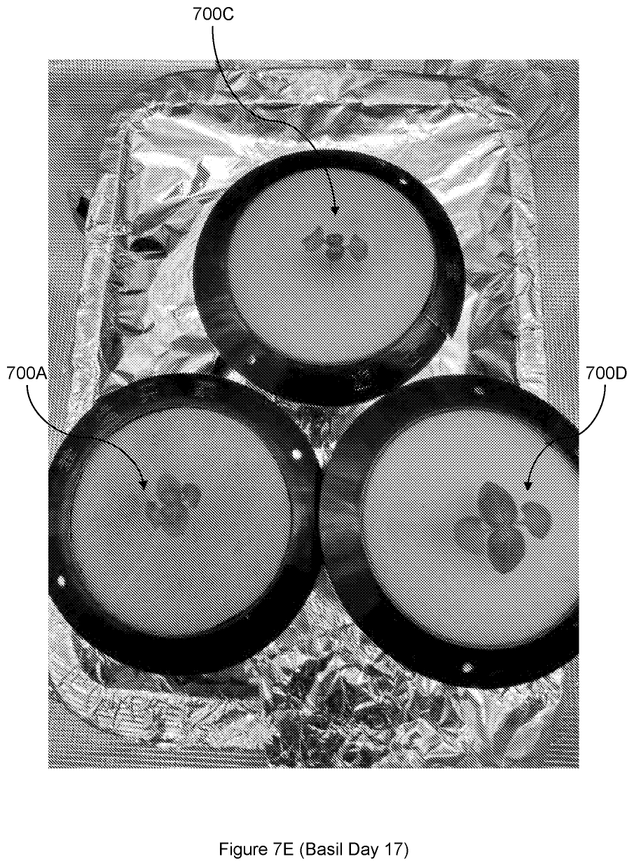

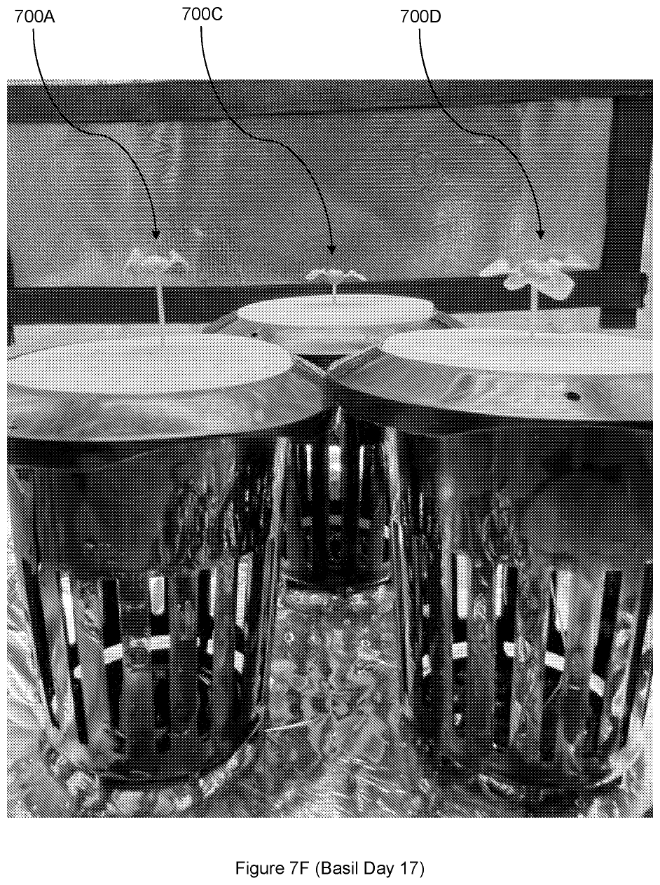

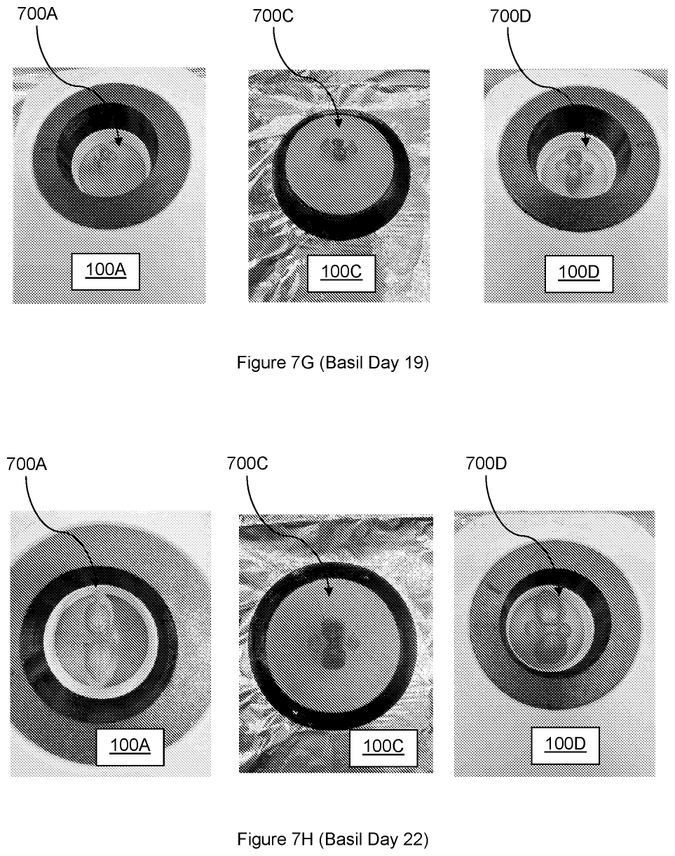

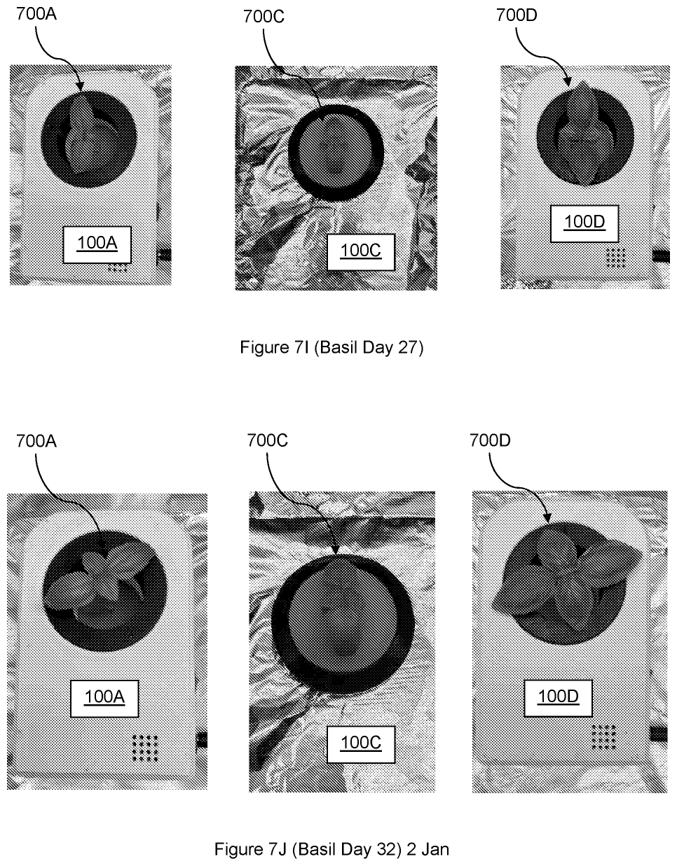

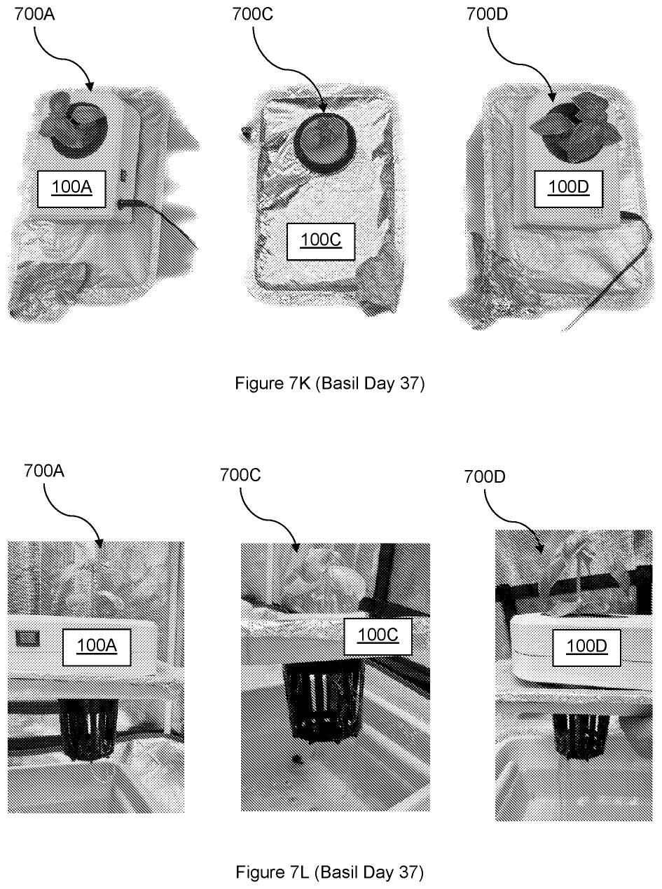

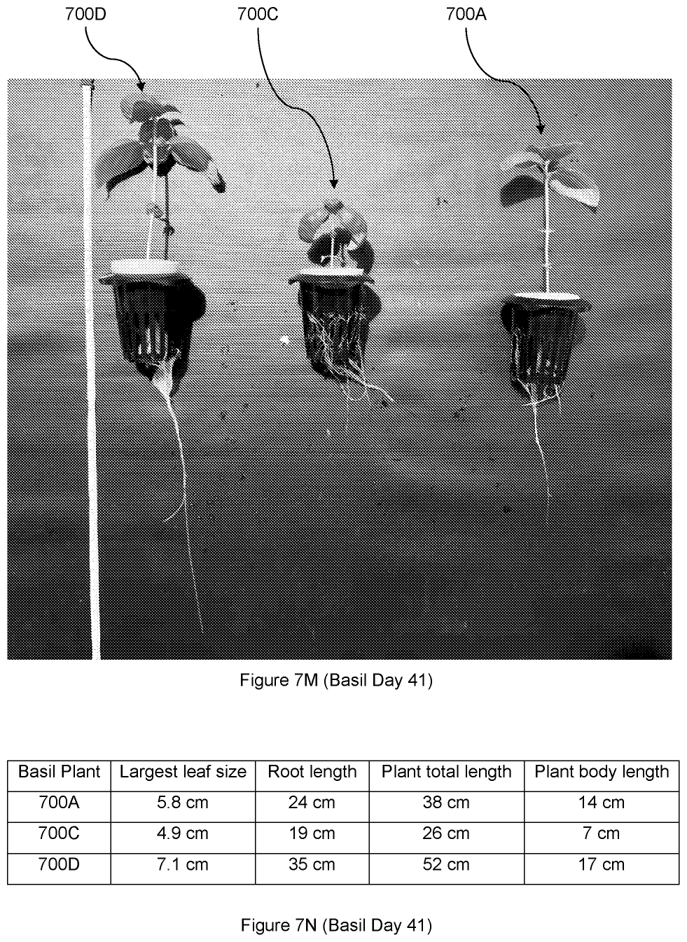

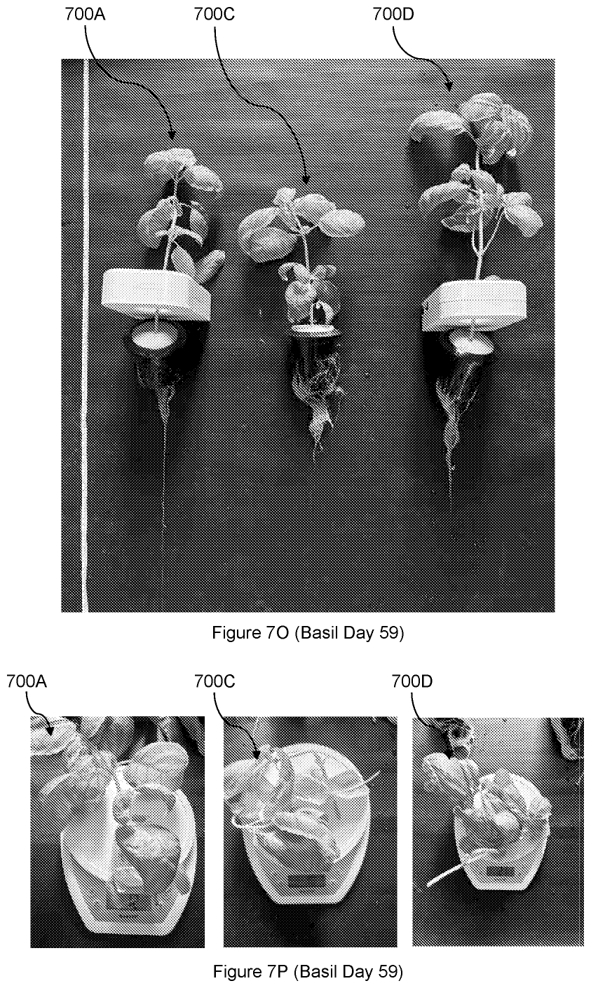

On Day 1 as shown in FIG. 7A, seeds of the basil plants 700 were sowed in soil. On Day 5 as shown in FIG. 7B, samples of the basil plants 700 of similar size were selected and transferred to the magnetic devices 100A, 100D and the control setup 100C. The first sample 700A was grown using the axial magnetic device 100A, the second sample 700C was grown in the control setup 100C, and the third sample 700D was grown using the diametrical magnetic device 100D. The samples of basil plants 700A,700C, 700D were grown using hydroponics for better accuracy in delivering the same amount of nutrients, thereby ensuring that the plant growth conditions are identical except for the magnetic fields.

On Day 9 as shown in FIG. 7C, the basil plant 700D had grown the second leaves, the basil plant 700A had not grown the second leaves yet, while the basil plant 700C had the lowest growth and size. The water for growing the basil plants 700 was changed for each setup and equal amounts of fertilizers were added into the replaced water to provide nutrients to the basil plants 700.

On Day 17 as shown in FIGS. 7D to 7F, the basil plant 700D had significantly larger second leaves and much greater root growth than the basil plants 700A,700C. The basil plant 700A was growing generally better than the basil plant 700C, which still had the lowest growth and size, but the root growth of the basil plant 700C was close to that of the basil plant 700A. The water for growing the basil plants 700 was changed for each setup and equal amounts of fertilizers were added into the replaced water.

On Day 19 as shown in FIG. 7G, the basil plant 700D had grown the second nodes, which were the two new leaves after the first two main leaves. The basil plants 700A, 700C had not grown the second nodes yet. The root mass of the basil plant 700D was also significantly larger and longer than those of the basil plants 700A, 700C.

On Day 22 as shown in FIG. 7H, all the basil plants 700A,700C, 700D had grown the second nodes. The basil plant 700D had shown significantly higher growth in leaf size and root mass compared to the basil plants 700A,700C. The basil plant 700A had showed better root growth and leaf size than the basil plant 700C. The water for growing the basil plants 700 was changed for each setup and equal amounts of fertilizers were added into the replaced water.

On Day 27 as shown in FIG. 7I, the basil plant 700D had grown the third nodes, which are the third set of leaves, and had much better root mass than the basil plants 700A, 700C. The leaves of the basil plant 700D are also larger than the leaves of the basil plants 700A, 700C, both of which had not grown the third nodes yet.

On Day 32 as shown in FIG. 7J, the basil plants 700A, 700C had now grown the third nodes. However, as the basil plant 700D had already grown the third nodes about 5 to 7 days earlier, the third nodes had developed into leaves. The basil plant 700D also had the largest root mass, followed by the basil plant 700A and then the basil plant 700C. The water for growing the basil plants 700 was changed for each setup and equal amounts of fertilizers were added into the replaced water.

On Day 37 as shown in FIGS. 7K and 7L, the basil plants 700A, 700C had grown the fourth nodes while the basil plant 700D had already grown the fifth nodes. The basil plant 700D also had the most root growth, followed by the basil plant 700A and then the basil plant 700C with the least root growth. The basil plant 700D was the tallest, followed by the basil plant 700A and then the basil plant 700C being the shortest.

On Day 41 as shown in FIG. 7M, various dimensions of the basil plants 700A,700C, 700D were measured and the measurements are shown in FIG. 7N. The measurements show that the basil plant 700D, which was grown using the diametrical magnetic device 100D with the rotating diametrical magnetic field, had the most root growth and longest root length, as well as the longest plant total length. For example, the basil plant 700D had 46% and 84% more root length than the basil plants 700A, 700C, respectively. For example, the basil plant 700D had 37% and 100% more total plant length than the basil plants 700A,700C, respectively.

On Day 59 as shown in FIGS. 7O and 7P, the basil plants 700A,700C,700D were weighed. The basil plant 700A weighed 12 g, the basil plant 700C weighed 10 g, and the basil plant 700D weighed 21 g. The basil plant 700A had 20% more weight than the basil plant 700C, and the basil plant 700D had 110% more weight than the basil plant 700C. The basil plant 700D had 75% more weight, albeit with slightly shorter root length, than the basil plant 700A. It can be seen from the measured weights that, for the same growth duration, the basil plant 700D was able to grow more strongly and achieve a larger weight than the other basil plants 700A,700C. The weight of the basil plants 700 is an important parameter for farmers as they can use the diametrical magnetic device 100D to increase the yield but without extending the growth duration.

The experiment results for the basil plants 700 clearly show that the rotating diametrical magnetic field significantly enhances plant growth compared to without any artificially generated magnetic field. The plant growth is also better with the rotating diametrical magnetic field than with the rotating axial magnetic field. Hence, plant growth can be improved by growing plants in the magnetic device 100 that generates a rotating magnetic field comprising both the diametrical and axial magnetic fields.

Although these experiments were performed on selected plant species including the tobacco plants 400, spinach plants 500, tomato plants 600, and basil plants 700, it will be appreciated that the rotating magnetic field can achieve similar benefits for other species of plants grown using the magnetic device 100. Moreover, in addition to plants that produce edible crops or food for people, the magnetic device 100 can be used for other types of plants such as those with medicinal benefits, such as cannabis.

When in use, the magnetic device 100 is attached to each individual plant, giving more attention to the plant and targeted exposure to the magnetic field. The rate of plant growth can be accelerated so that the plants grow to maturity more quickly, and the size of the adult plants can also be increased. The magnetic device 100 provides a cost effective and efficient way to enhance plant growth and hence increase the yield of plants, particularly agricultural crops for food production. Due to better nutrient and water absorption when the magnetic device 100 is used, there is less nutrient wastage and the amount of fertilizers used can be reduced. The rotating magnetic field also improves resistance to weather and fungi and has a repulsive effect on some insects.

Multiple magnetic devices 100 can be used in a greenhouse for enhancing growth of a large batch of plants of various species. The magnetic devices 100 have long lifespans and can be used for many harvests. Due to the better absorption of nutrients and repulsive effect on pests, the amount of fertilizers and pesticides used in each harvest can be reduced, thus helping the greenhouse to lower costs while improving plant yield and quality. Use of the magnetic devices 100 thus provides a commercially viable way to increase agricultural crop yield to address future food demand.

In the foregoing detailed description, embodiments of the present disclosure in relation to a magnetic device and method for growing plants are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A magnetic device for growing plants, the magnetic device comprising:
a body comprising a space for enclosing a base of the plants and growing the plants axially out of the space along a vertical axis;
a set of magnetic elements coupled to the body and surrounding the space about the vertical axis, the magnetic elements configured for generating a magnetic field in the space; and
an actuation mechanism coupled to the body and configured for rotating the magnetic elements around the space and about the vertical axis, thereby rotating the magnetic field around the space and about the vertical axis,
wherein in use, the base of the plants is surrounded by the magnetic elements and exposed to the rotating magnetic field to thereby enhance growth of the plants.

2. The magnetic device according to claim 1, wherein the magnetic field comprises:
an axial magnetic field axially through the space and along the vertical axis; and/or
a diametrical magnetic field diametrically across the space and perpendicular to the vertical axis.

3. The magnetic device according to claim 1, wherein the magnetic elements comprise a set of permanent magnets and/or a set of electromagnets.

4. The magnetic device according to claim 1, wherein the actuation mechanism comprises an electric motor and/or a mechanically-activated mechanism.

5. The magnetic device according to claim 1, further comprising a control unit for controlling the magnetic elements and/or the actuation mechanism.

6. The magnetic device according to claim 5, wherein the control unit is configured for controlling the actuation mechanism to vary a rotational speed of the magnetic elements.

7. The magnetic device according to claim 5, wherein the control unit is configured for controlling the magnetic elements to vary a magnetic strength of the magnetic field.

8. The magnetic device according to claim 5, wherein the control unit is communicative with a remote electronic device for remote control of the magnetic device.

9. The magnetic device according to claim 1, further comprising a set of sensors for measuring ambient conditions of an environment in which the plants are grown.

10. The magnetic device according to claim 9, wherein the ambient conditions comprise one or more of temperature, humidity, and soil moisture.

11. A method for growing plants, the method comprising:
enclosing a base of the plants within a space of a device body;
growing the plants axially out of the space along a vertical axis;
generating a magnetic field in the space by a set of magnetic elements coupled to the device body, the magnetic elements surrounding the space about the vertical axis and surrounding the base of the plants;
rotating the magnetic elements around the space and about the vertical axis by an actuation mechanism coupled to the device body to thereby rotate the magnetic field around the space and about the vertical axis; and
exposing the base of the plants to the rotating magnetic field to thereby enhance growth of the plants.

12. The method according to claim 11, wherein generating the magnetic field comprises:
generating an axial magnetic field axially through the space and along the vertical axis; and/or generating a diametrical magnetic field diametrically across the space and perpendicular to the vertical axis.

13. The method according to claim 11, comprising controlling the magnetic elements and/or the actuation mechanism using a control unit.

14. The method according to claim 13, comprising controlling, using the control unit, the actuation mechanism to vary a rotational speed of the magnetic elements.

15. The method according to claim 13, comprising controlling, using the control unit, the magnetic elements to vary a magnetic strength of the magnetic field.

16. The method according to claim 13, comprising communicating with the control unit using a remote electronic device.

17. The method according to claim 11, comprising measuring ambient conditions of an environment in which the plants are grown.

18. The method according to claim 17, wherein the ambient conditions comprise one or more of temperature, humidity, and soil moisture.

19. The method according to claim 11, wherein the magnetic elements comprise a set of permanent magnets and/or a set of electromagnets.

20. The method according to claim 11, wherein the actuation mechanism comprises an electric motor and/or a mechanically-activated mechanism.
